(19) United States
(12) Patent Application Publication
(10) Pub. No.: US 2013/0166353 A1
(43) Pub. Date: Jun. 27, 2013

(54) PRICE OPTIMIZATION USING RANDOMIZED SEARCH

(71) Applicants: Kresimir MIHIC, San Diego, CA (US); David VENGEROV, San Jose, CA (US); Andrew VAKHUTINSKY, Burlington, MA (US)

(72) Inventors: Kresimir MIHIC, San Diego, CA (US); David VENGEROV, San Jose, CA (US); Andrew VAKHUTINSKY, Burlington, MA (US)

(73) Assignee: ORACLE INTERNATIONAL CORPORATION, Redwood Shores, CA (US)

(21) Appl. No.: 13/332,721

(22) Filed: Dec. 21, 2011

(51) Int. Cl. G06Q 30/00

(52) U.S. Cl. 705/7.35; 705/400

(57) ABSTRACT

A price optimization system determines the pricing of a plurality of items. The system receives an initial price vector for the items and an objective function, and assigns the initial price vector as a current price vector. The system determines a first new price vector by randomly choosing a first set of allowed prices for the items, and assigning the first set of allowed prices as the current price vector when the objective function is improved. The system then determines a second new price vector by randomly choosing a second set of allowed prices for the items and assigning the second set of allowed prices as the current price vector when the objective function does not decrease by more than a predetermined value. The system sequentially repeats this functionality until a terminating criteria is reached and then it determines the pricing.

### FIELD

One embodiment is directed generally to a computer system, and in particular to a computer system that optimizes product pricing.

### BACKGROUND INFORMATION

Product line pricing is an important business problem faced by retailers and other sellers of merchandise who employ dynamic pricing strategies to generate incremental revenue benefits throughout the year. Retailers, among others, have in increasing numbers begun to utilize decision support systems that leverage the large volume of detailed demand data to automate and optimize pricing recommendations. In particular, the statistical modeling of the price elasticity of items based on analyzing the effect of price changes of one product on its demand, or the demand for another product, can be used to optimize the pricing of products.

Known price optimizers, in general, are given a set of items in a product category together with their current prices and demand cross-elasticity. The optimizers then find a new set of prices that would satisfy all business rules and maximize the desired objective (e.g., profit margin, revenue, etc.) by taking into account some soft price constraints and allowed prices.

### SUMMARY

One embodiment is a price optimization system that determines the pricing of a plurality of items. The system receives an initial price vector for the items and assigns the initial price vector as a current price vector. The system further receives an objective function. The system determines a first new price vector by exploiting the current price vector, where the exploiting includes randomly choosing a first set of allowed prices for the items, and when the first set of allowed prices improves the objective function, assigning the first set of allowed prices as the current price vector. The system then determines a second new price vector by exploring the current price vector, where the exploring includes randomly choosing a second set of allowed prices for the items, and when the second set of allowed prices does not decrease the objective function by more than a predetermined value, assigning the second set of allowed prices as the current price vector. The system sequentially repeats the exploiting and exploring functionality until a terminating criteria is reached. When the terminating criteria is reached, the current price vector is the determined pricing of the plurality of items.

### BRIEF DESCRIPTION OF THE DRAWINGS

FIG. 1 is a block diagram of a computer system that can implement an embodiment of the present invention.

FIG. 2 is a flow diagram of the overall functionality of the product pricing module of FIG. 1 when generating optimized product pricing using two sequential randomized search phases, an exploitation phase and exploitation phase, in accordance with one embodiment.

FIGS. 3a and 3b is a flow diagram of the functionality of the product pricing module when determining a new price vector by executing the exploitation phase or the exploitation phase in accordance with one embodiment.

### DETAILED DESCRIPTION

One embodiment is a product price optimizer that searches for optimal pricing using two sequential randomized search phases, an “exploration” phase and an “exploitation” phase. The phases alternate until the there is a convergence to an optimal solution or until a maximum run time is reached. Each phase consists of repetitive cycles where the items are considered in random order using uniform probability distribution. In the exploitation phase, new solutions are accepted if they improve an objective function such as maximal revenue or gross margin. In the exploration phase, new solutions are accepted if they do not decrease the previously found best objective value by more than a specified percentage.

One embodiment is directed to a price optimizer for setting the prices of items in each category carried by a large retail store so as to maximize an “objective function”, which in general depends on the sales volume of all items. The most common metric for the objective function is profit or revenue. When the prices of items are changed, the change in the sales volume of each item depends on the product of the percentage changes in the prices of all other items, with each percentage change usually raised to some power. Therefore, the objective function is a nonlinear function of the prices. Further, every feasible price vector (i.e., the determined prices of all items) must generally satisfy multiple constraints, some of which specify that the profit, revenue, and sales volume have to be greater than a certain specified fraction of the original profit, revenue and sales volume. Therefore, the constraints are also nonlinear.

In general, a Linear Programming (“LP”) methodology is the standard methodology for solving constrained optimization problems with linear constraints and a linear objective function. However, the nonlinearities present in many price optimization problems, as discussed above, require problem-specific approximations and linearizations to be made before the LP approach can be used, and a solution found using LP will necessarily be suboptimal. Further, the nonlinearity of constraints implies that the solution set is not convex, which means there may be multiple local maxima for the objective function, and hence nonlinear gradient search methods will in general not find the global maximum of the “price optimization problem”.

Many real-world optimization problems are formulated to minimize or maximize the nonlinear function of discrete variables subject to certain constraints involving that function or some linear functions of its arguments. An example of this problem type, the price optimization problem, is the maximization of the objective function of total revenue for several merchandise items in a category where demand for each item is expressed as a nonlinear function of all item prices, which can take values only from specific price ladders (i.e., a set of allowed prices). The price optimization problem can be stated as follows:

Find the best prices (p₁, . . . , pₙ) for the n product items in a given merchandise category to maximize the total revenue subject to certain linear constraints when demand for the i^{th} item is expressed as a given demand function dᵢ(p₁, . . . , pₙ) (i.e., a demand model). The problem can also be expressed as follows:

$$\begin{matrix}max {\sum }_{i = 1}^{n} {p}_{i} {d}_{i} ( {p}_{1} , … , {p}_{n} ) & ( 1 ) \\ subject {p}_{i} ∈ \{ {p}_{i}^{1} , … , {p}_{i}^{{M}_{i}} \} ≡ {P}_{i} i = 1 , … , n & ( 2 ) \\ to ( {p}_{1} , … , {p}_{n} ) ∈ {L}_{p} \\ ( {d}_{1} , … , {d}_{n} ) ∈ {L}_{d} \\ ( {p}_{1} {d}_{1} , … , {p}_{n} {d}_{n} ) ∈ {L}_{r} & ( 3 )\end{matrix}$$

where dᵢ(p₁, . . . , pₙ) is a nonlinear expression for the i^{th} item demand as a function of all prices in the category; Pᵢ is the price ladder (discrete set) for the i^{th} item; and Lₚ (L_{d}, Lᵣ) are the feasible price (demand and revenue, respectively) regions defined by the linear inter-item constraints. Each item i has a cost associated with it.

In known product pricing optimizers that generate optimized prices, the optimization problem shown in equations (1-3) above is solved by a series of greedy searches, which sometimes delivers a solution far from optimal. Other known approaches are based on linear or quadratic approximations of the nonlinear demand function. However, these approaches tend to suffer from insufficient accuracy (linear approximation) or an overwhelming number of integer variables needed to formulate the problem.

In contrast with known LP approaches of optimizing prices, embodiments of the present invention use randomized search (“RS”) to arrive at an optimal or near optimal solution to the price optimization problem, despite its nonlinearities. In general, one embodiment is a price optimizer that calculates a set of recommended prices or validates a set of user-defined input prices, given one or more of the following inputs:
Sales and cost data for a given demand group and location;
Current prices and competitor prices per demand group;
Pricing and competition constraints per demand group;
Goals for sales, revenue, gross-margin, and competitive price index (“CPI”) per demand group;
Weighted objective function that is a linear combination of the sales, revenue, gross-margin, and CPI per demand group;
Choice of the demand forecast model; and
Certain demand model parameters for the chosen forecast model.

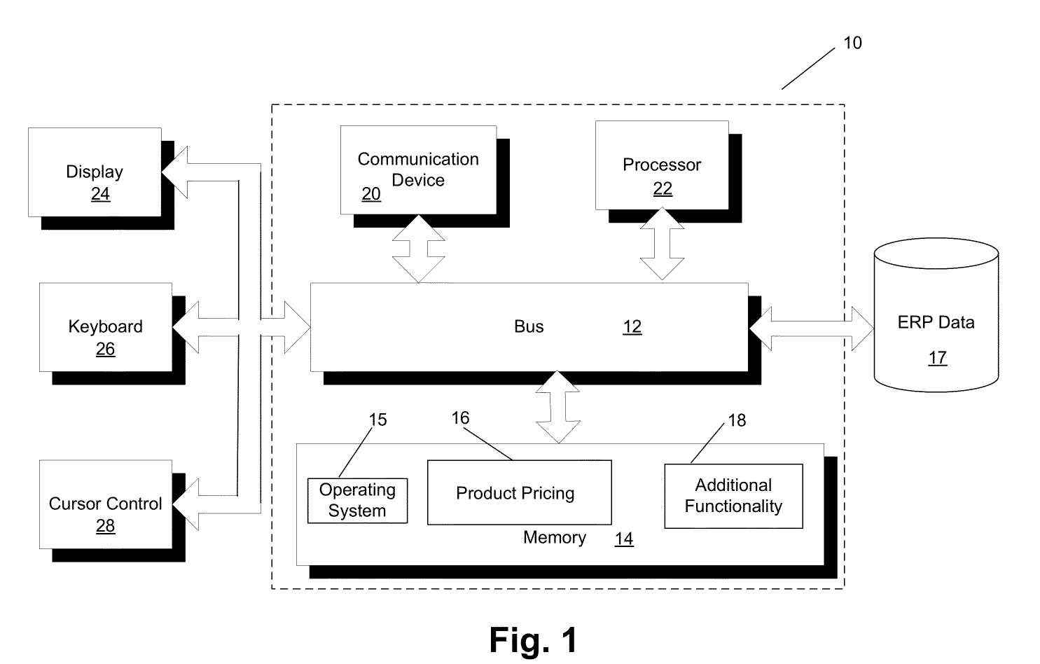

FIG. 1 is a block diagram of a computer system 10 that can implement an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include a product pricing module 16 that generates optimized product pricing using randomized search, as disclosed in more detail below. System 10 can be part of a larger system, such as an enterprise resource planning (“ERP”) system. Therefore, system 10 will typically include one or more additional functional modules 18 to include the additional functionality. A database 17 is coupled to bus 12 to provide centralized storage for modules 16 and 18 and store pricing information, inventory information, ERP data, etc.

In one embodiment, a revenue maximization problem is developed and solved for category pricing in the retail industry. However, in other embodiments this problem can be used for any type of product pricing. For the retail embodiment, consider a retailer who has to set the baseline (or regular) price levels for some or all active items in a given category for the next few months, as part of a merchandise planning process. The category manager has to make multiple, coordinated pricing decisions, proactively taking into account the impact of a price change on the sales of other items within the category, as well as any (extraneous) market response. Moreover, the recommended prices have to satisfy several category-level objectives such as profitability, sales, and revenue (e.g., to maximize gross margin while ensuring that the total sales and revenue are within 10% of the current value), and have to be selected from within a limited discrete price ladder (e.g., be within 20% of the current price and end with ‘9’ cents). In addition, items have to be priced relative to certain attributes such as brand type (e.g., a store brand tomato soup should be at least a dollar less than the price of the corresponding national brand), and quantity (e.g., a six-pack of diet-soda versus a two-liter bottle of diet-soda), among others.

Items can represent stock-keeping units (“SKU”s), product subclasses, or product classes within the category, depending on the level of aggregation in the merchandise hierarchy at which the analysis is performed by the category manager. For simplicity, it is assumed that prices of SKUs are optimized at the store-level of the location hierarchy. However, in other embodiments, the problem can be readily extended to manage higher levels of aggregation (e.g., at the zonal level). Further, the problem can address more general situations faced by category managers such as the need to jointly optimize multiple categories that are inter-linked by pricing constraints and/or objectives, or manage several distinct subsets of substitutable items within the same category.

As disclosed, one embodiment determines a set or vector of optimized prices that maximize an objective function and meets all constraints. The constraints can be expressed as follows:
Price Constraints: For each item i ∈ I, the price pi ∈ P:
   must be chosen from the set of allowed prices for the item i (price ladder);
   must meet constraints of type: aₖ*pᵢ+bₖ*pⱼ≦dₖ, ∀j ∈ I and k ∈ N;
   should be as close as possible to the original price of the item i.
Constraints on the total number of items allowed to have their prices changed.
Business constraints:
   Volume(p)≧αVolume(pₒ);
   Margin(p)≧βMargin(pₒ);
   Revenue(p)≧δRevenue(pₒ), etc.;
where pₒ is the original price vector and α, β, δ ∈[0,1].

In one embodiment, the objective function or value can be expressed as follows:
Supporting the multi-objective optimization by using the weights:

f₀=Wᵥ·Volume+Wᵣ·Revenue+Wₘ·Margin
Revenue and Margin are functions of sales volume and the price vector;
Sales volume is a function of the price vector and “elasticity” matrix;
“Elasticity” matrix γ correlates prices along the items and defines how much a change in pricing of item i affects volume of item j:

$${V}_{i} = {V}_{i}^{0} \cdot {\prod }_{j ∈ I} {( \frac{{p}_{j}}{{p}_{j}^{0}} )}^{γ ij} : ∀ i ∈ I .$$

One embodiment searches for optimal pricing using the two sequential randomized search phases, the “exploration” phase and the “exploitation” phase. The phases alternate until the there is a convergence to an optimal solution or until a maximum run time is reached. Each phase consists of repetitive cycles where the items are considered in random order using uniform probability distribution. In the exploitation phase, new solutions are accepted if they improve an objective function such as maximal revenue or gross margin. In the exploration phase, new solutions are accepted if they do not decrease the previously found best objective function by more than a specified percentage.

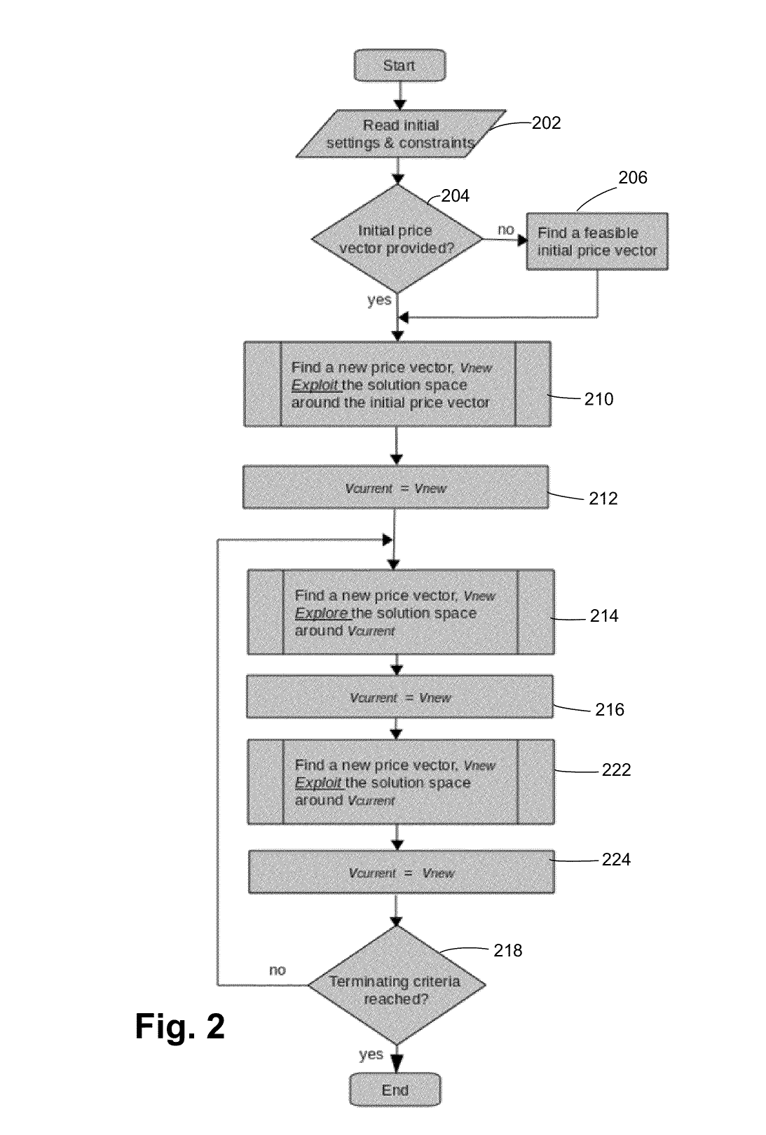

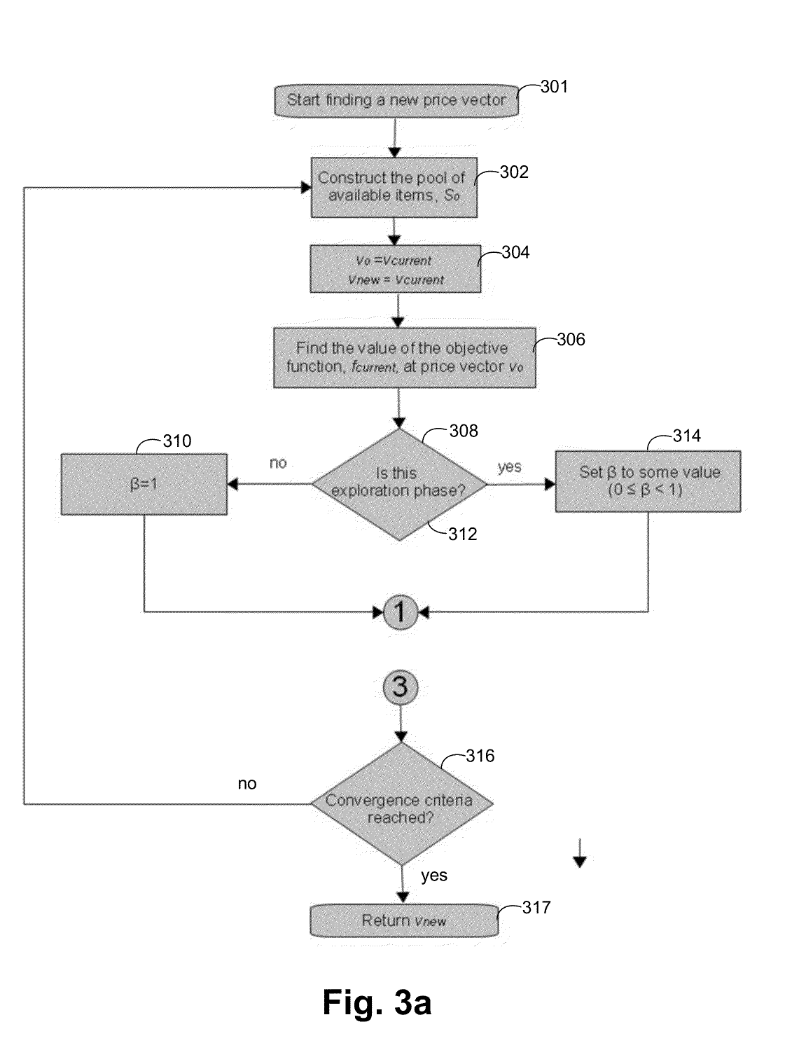

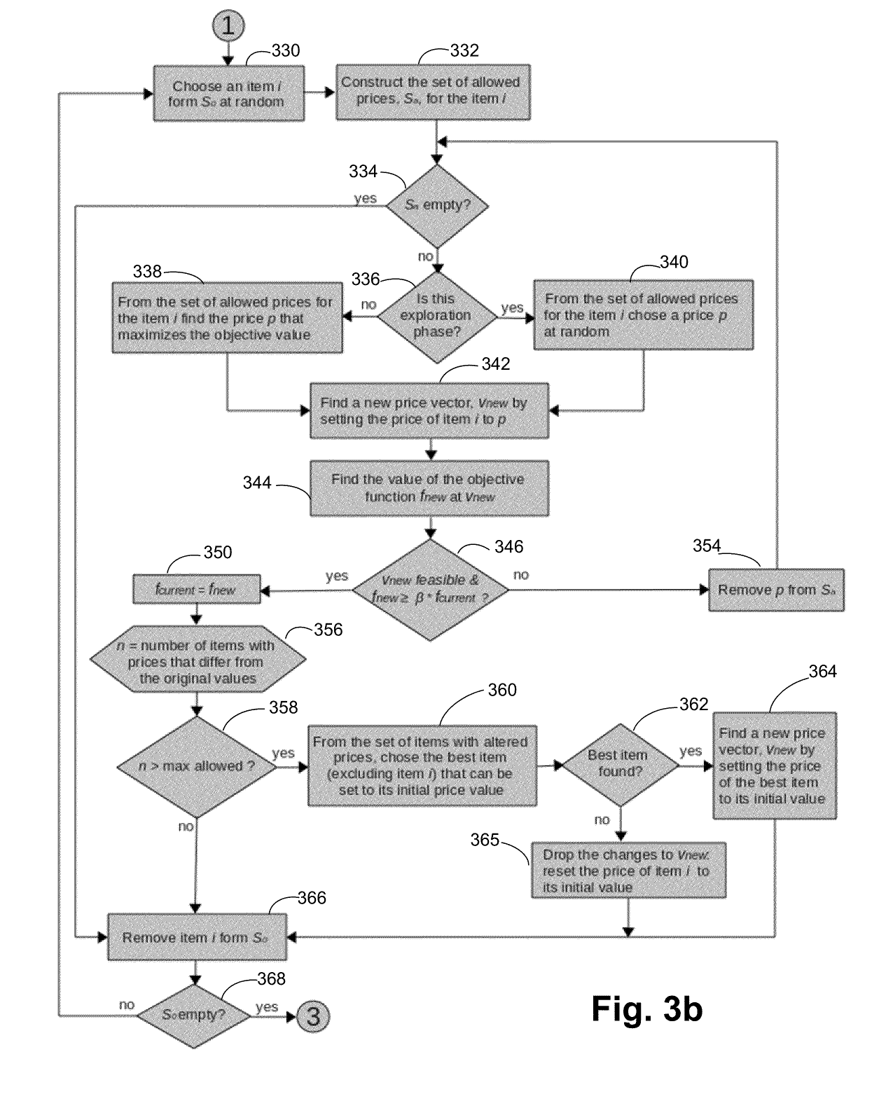

FIG. 2 is a flow diagram of the overall functionality of product pricing module 16 of FIG. 1 when generating optimized product pricing using two sequential randomized search phases, an exploitation phase and exploitation phase, in accordance with one embodiment. In one embodiment, the functionality of the flow diagram of FIG. 2, and FIGS. 3a and 3b discussed below, is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 202, the initial setting and constraints are received.

At 204, it is determined if an initial price vector is provided. If no, at 206 a feasible initial price/solution vector is found. A feasible initial price vector in one embodiment is an assigned price for all items of interest, where the price for each item is one of the discrete prices on a pricing ladder for each item. The initial price vector is the vector of currently used prices. If, for example, a user was attempting to find optimal prices for a brand new store with no current prices, an initial price vector can be chosen randomly and the functionality of module 16 will ultimately arrive at optimized pricing.

If yes at 204, at 210, a new price vector, “v_{new}” is found via the “exploitation” phase that exploits the solution space around the initial price vector. The exploitation phase portion of determining a new price vector, as disclosed in more detail in conjunction with FIGS. 3a and 3b below, accepts new solutions if they improve an objective function such as maximal revenue or gross margin. Details of the functionality of determining the new price vector for 210 begins at 301 of FIG. 3a.

At 212, v_{current}=v_{new}.

At 214, new price vector, “v_{new}” is found via the “exploration” phase that explores the solution space around v_{current}. The exploration phase portion of determining a new price vector, as disclosed in more detail in conjunction with FIGS. 3a and 3b below, accepts new solutions if they do not decrease the previously found best objective value by more than a specified percentage. Details of the functionality of determining the new price vector for 214 begins at 301 of FIG. 3a.

At 216, v_{current}=v_{new}.

At 222, as in 210, a new price vector, “v_{new}” is found via the “exploitation” phase that exploits the solution space around v_{current}.

At 224, v_{current}=v_{new}.

At 218, it is determined if a terminating criteria is reached, for example a limit of how many cycles of steps 214, 216, 222 and 224 are executed without realizing improvements in the objective value. In one embodiment, if three cycles of 214, 216, 222 and 224 are executed without improvement, the functionality of FIG. 2 is ended.

If the terminating criteria is reached at 218, the functionality of FIG. 2 is ended, and v_{current} is the determined price vector which represents optimized assigned prices. If no at 218, the functionality continues at 214.

FIGS. 3a and 3b is a flow diagram of the functionality of product pricing module 16 when determining a new price vector by executing the exploitation phase or the exploitation phase in accordance with one embodiment.

At 301, the functionality of finding a new price vector is initiated.

At 302, the pool of available items, “Sₒ”, is constructed.

At 304, variables vₒ and v_{new} are set: vₒ=v_{current} and v_{new}=v_{current}.

At 306, the value of the objective function, “f_{current}”, is found at price vector vₒ. As disclosed above, in one embodiment the objective function is determined by f₀=Wᵥ·Volume+Wᵣ·Revenue+Wₘ·Margin where the Volume is determined as follows:

$${V}_{i} = {V}_{i}^{0} \cdot {\prod }_{j ∈ I} {( \frac{{p}_{j}}{{p}_{j}^{0}} )}^{γ ij} : ∀ i ∈ I .$$

The total revenue for each item “k” is the sum over all items k of the volumeₖ*priceₖ, and the profit margin is the sum over all items k of volumeₖ*(priceₖ−costₖ), where costₖ (i.e., the cost of each item) is known ahead of time.

At 308, it is determined if the functionality is the exploration phase (i.e., whether 301 of FIG. 3a was initiated from 214 of FIG. 2). If exploration phase at 308, then at 314, β is set to some value, where 0≦β≦1. If exploitation phase at 308 (i.e., in the exploitation phase because 301 of FIG. 3a was initiated from 210 or 222 of FIG. 2), at 310, β=1. The functionality then continues at 330 of FIG. 3b.

At 330, an item “i” is chosen from Sₒ at random. [At 332, the set of allowed prices (i.e., prices from the price ladder, and taking into account inter-item constraints), Sₐ, for the item i is constructed. At 334, it is determined if Sₐ is empty. If there are no price levels in the price ladder for which the constraints are satisfied, then Sₐ is empty. The set Sₐ may be repeatedly revisited through the functionality of FIG. 3b, and after every visit one price level is removed from Sₐ at 366. Therefore, if Sₐ is visited too many times, it will become empty at 334.

If yes at 334, functionality continues at 366 where an item i is removed from Sₒ.

If no at 334, at 336 it is determined if the functionality is the exploration phase (i.e., whether 301 of FIG. 3a was initiated from 214 of FIG. 2).

If yes at 336, at 340 a price p is chosen at random from the set of allowed prices for the item i.

If no at 336, at 338, from the set of allowed prices for the item i the price p is found that maximizes the objective value. In one embodiment, since there is usually a small number of price levels for each item i, all price levels for item i are tried in the objective function disclosed above, and the one that maximizes the objective function is chosen.

At 342, a new price vector, v_{new,} is found by setting the price of item i to p.

At 344, the value of the objective function f_{new} is determined at v_{new}.

At 346, it is determined if v_{new} is feasible and if f_{new}≧β*f_{current}. This decision accounts for the random choice for the exploration phase and because of inter-item constraints for both phases. The objective function algorithm checks only for business constraints feasibility, and not for inter-item prices. The inter-item constraints are accounted for at 332 where the set of allowed prices is constructed.

If no at 346, at 354 p is removed from Sₐ and the functionality continues at 334.

If yes at 346, at 350 f_{current}=f_{new}.

At 356, variable “n” equals the number of items with prices that differ from the original values.

At 358, it is determined if n is greater than a predetermined maximum number. If yes at 358, at 360, from the set of items with altered prices, the best item (excluding item i) is chosen that can be set to its initial price value. The “best” item is the one which results in the largest value of the objective function once this item is reset back to the price level in v_{current}.

At 362, it is determined if the best item is found. If no at 362, at 365 the changes done to v_{new} are revoked by resetting the price of item i to its initial value and then at 366 removing the current item i from Sₒ. If yes at 362, at 364 a new price vector, v_{new}, is found by setting the price of the best item to its initial value. Functionality then continues at 366.

If no at 358, at 366 item i is removed from Sₒ.

At 368, it is determined if Sₒ is empty. If no at 368, functionality continues at 330. If yes at 368, functionality continues at 316 of FIG. 3a.

At 316 of FIG. 3a, it is determined if a terminating or convergence criteria, such as a fixed predetermined number of iterations has been reached. If yes, v_{new} is returned to either 210, 214 or 222 of FIG. 2, depending on which called for determining a new price vector. If no at 316, the functionality continues at 302.

As disclosed, one embodiment optimizes prices using two sequential phases, an exploration and exploitation phase, that alternate until there is a convergence to some locally optimal solution or until a maximum run time is reached. Each phase consists of repetitive cycles where the items are considered in random order using uniform probability distribution. In the exploitation phase, new solutions are accepted only if they improve the objective function. In the exploration phase, new solutions are accepted if they do not decrease the previously found best objective value by more than a specified percentage number.

The following pseudo-code can be used to implement the overview functionality in accordance with one embodiment:
1: find an initial (feasible) solution vector, if not provided.
2: exploit the solution space around the initial vector: search for the solution that improves the objective value.
3: repeat
4: explore the neighborhood of the best vector found in the previous loop.
5: exploit the solution space around the best vector found during the exploration phase.
6: until terminating criteria is reached.

The following pseudo-code can be used to implement the exploitation phase functionality in accordance with one embodiment:
1: Let S₀ be the current solution vector.
2: for each component i ∈ S₀ (randomly chosen without replacement) do
3: among all the values allowed for the component i find the one that maximizes (minimizes) the objective value. Set i to that value.
4: If number of items with prices that differ from the original price max allowed +1, set the price of the best item (excluding the item from step 1) to its original value.
5: Accept the new candidate solution vector if it improves the previously found best objective value.
6: end for.

The following pseudo-code can be used to implement the exploration phase functionality in accordance with one embodiment:

| | |
|---|---|
| 1: | Let S₀ be the current solution vector. |
| 2: | for each component i ε S₀ (randomly chosen without replacement) |
| | do |
| 3: | choose a value from the set of all the values allowed for the |
| | variable i at random. |
| 4: | If number of items with prices that differ from the original price ≧ |
| | max allowed + 1, set the price of the best item (excluding the item |
| | from step 1) to its original value. |
| 5: | Accept the candidate solution vector if it does not decrease the |
| | previously found best objective value by more than a specified |
| | percentage number. |
| 6: | end for. |

Embodiments can be applied to a large class of problems in addition to product pricing. Embodiments are especially suited for solving problems: that have a large number of input variable dimensions (typically hundreds or thousands), each of which can be either discrete or can be reduced to discrete; that are non-linear and non-convex; that include complex constraints among the function's input and output variables; and where there is no need for the optimal solution but for an improvement over the existing one.

An example of problems that can be ideally solved by embodiments of the present invention include a price optimization problem that includes thousands of dimensions (e.g., items in a grocery store). The item prices are constrained by “magic” numbers (e.g., $3.99, $4.99, not $4.31). The goal is to improve profit without changing initial prices of too many items. The need is to find a solution for a single store in 30 seconds.

Another example is a seating problem for a large corporate meeting. The problem includes thousands of dimensions (e.g., employees with different location possibilities). The goal is to improve the proximity of members within a working group. Constraints include only wanting to consider 100 moves or fewer. Another example problem is the allocation/reallocation of virtual machines in a cloud for improved resource utilization and energy savings.

Several embodiments are specifically illustrated and/or described herein. However, it will be appreciated that modifications and variations of the disclosed embodiments are covered by the above teachings and within the purview of the appended claims without departing from the spirit and intended scope of the invention.

1. A non-transitory computer readable medium having instructions stored thereon that, when executed by a processor, causes the processor to determine pricing of a plurality of items, the pricing determination comprising:
receiving an initial price vector for the items and assigning the initial price vector as a current price vector, wherein the initial price vector comprises a set of prices for each of the items;
receiving an objective function, wherein the objective function comprises at least revenue or margin;
determining a first new price vector by exploiting the current price vector, wherein the exploiting comprises randomly choosing a first set of allowed prices for the items, and when the first set of allowed prices improves the objective function, assigning the first set of allowed prices as the current price vector, wherein when the objective function is revenue or margin, an increase in objective function improves the objective function, and wherein the exploiting comprises selecting the first set of allowed prices for the items because the objective function is improved for the first set of allowed prices more than all other randomly chosen sets of allowed prices for the items;
determining a second new price vector by exploring the current price vector after the determining the first new price vector, wherein the exploring comprises randomly choosing a second set of allowed prices for the items, and when the second set of allowed prices does not decrease the objective function by more than a predetermined value, assigning the second set of allowed prices as the current price vector; and
sequentially repeating the exploiting and exploring until a terminating criteria is reached, wherein when the terminating criteria is reached, the current price vector is the determined pricing of the plurality of items.

2. (canceled)

3. The computer readable medium of claim 1, wherein the objective function is based on a sales volume of the items.

4. The computer readable medium of claim 1, wherein the objective function is a nonlinear function of prices of the items.

5. The computer readable medium of claim 1, wherein allowed prices for the items comprises satisfying one or more constraints.

6. The computer readable medium of claim 5, wherein the constraints comprise at least one of: price constraints, business constraints, or constraints on a total number of items allowed to have changed prices.

7. The computer readable medium of claim 6, wherein the price constraints comprise a price ladder.

8. A method for determining a pricing of a plurality of items, the method comprising:
receiving an initial price vector for the items and assigning the initial price vector as a current price vector, wherein the initial price vector comprises a set of prices for each of the items;
receiving an objective function, wherein the objective function comprises at least revenue or margin;
determining by a processor a first new price vector by exploiting the current price vector, wherein the exploiting comprises randomly choosing a first set of allowed prices for the items, and when the first set of allowed prices improves the objective function, assigning the first set of allowed prices as the current price vector, wherein when the objective function is revenue or margin, an increase in objective function improves the objective function, and wherein the exploiting comprises selecting the first set of allowed prices for the items because the objective function is improved for the first set of allowed prices more than all other randomly chosen sets of allowed prices for the items;
determining a second new price vector by exploring the current price vector after the determining the first new price vector, wherein the exploring comprises randomly choosing a second set of allowed prices for the items, and when the second set of allowed prices does not decrease the objective function by more than a predetermined value, assigning the second set of allowed prices as the current price vector; and
sequentially repeating the exploiting and exploring until a terminating criteria is reached, wherein when the terminating criteria is reached, the current price vector is the determined pricing of the plurality of items.

9. (canceled)

10. The method of claim 8, wherein the objective function is based on a sales volume of the items.

11. The method of claim 8, wherein the objective function is a nonlinear function of prices of the items.

12. The method of claim 8, wherein allowed prices for the items comprises satisfying one or more constraints.

13. The method of claim 12, wherein the constraints comprise at least one of: price constraints, business constraints, or constraints on a total number of items allowed to have changed prices.

14. The method of claim 13, wherein the price constraints comprise a price ladder.

15. A price optimization system comprising:
a processor;
a memory coupled to the processor and storing instructions that, when executed by the processor, determine a pricing of a plurality of items comprising:
receiving an initial price vector for the items and assigning the initial price vector as a current price vector, wherein the initial price vector comprises a set of prices for each of the items;
receiving an objective function, wherein the objective function comprises at least revenue or margin;
determining a first new price vector by exploiting the current price vector, wherein the exploiting comprises randomly choosing a first set of allowed prices for the items, and when the first set of allowed prices improves the objective function, assigning the first set of allowed prices as the current price vector, wherein when the objective function is revenue or margin, an increase in objective function improves the objective function, and wherein the exploiting comprises selecting the first set of allowed prices for the items because the objective function is improved for the first set of allowed prices more than all other randomly chosen sets of allowed prices for the items;
determining a second new price vector by exploring the current price vector after the determining the first new price vector, wherein the exploring comprises randomly choosing a second set of allowed prices for the items, and when the second set of allowed prices does not decrease the objective function by more than a predetermined value, assigning the second set of allowed prices as the current price vector; and
sequentially repeating the exploiting and exploring until a terminating criteria is reached, wherein when the terminating criteria is reached, the current price vector is the determined pricing of the plurality of items.

16. (canceled)

17. The system of claim 15, wherein the objective function is based on a sales volume of the items.

18. The system of claim 15, wherein the objective function is a nonlinear function of prices of the items.

19. The system of claim 15, wherein allowed prices for the items comprises satisfying one or more constraints.

20. The system of claim 19, wherein the constraints comprise at least one of: price constraints, business constraints, or constraints on a total number of items allowed to have changed prices.

21. The system of claim 20, wherein the price constraints comprise a price ladder.
